(19) United States
(12) Patent Application Publication
(10) Pub. No.: US 2009/0096793 A1
(43) Pub. Date: Apr. 16, 2009

(54) IMAGE PROCESSING METHOD, PROGRAM THEREOF AND IMAGE PROCESSING APPARATUS

(75) Inventors: Masahiko Hirasawa, Sapporo-shi (JP); Hiroaki Nakanishi, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/252,259

(22) Filed: Oct. 15, 2008

(30) Foreign Application Priority Data
Oct. 16, 2007 (JP) 2007-269120

(51) Int. Cl. G06T 11/20; G06F 3/12

(52) U.S. Cl. 345/441; 358/1.1

(57) ABSTRACT

An electronically implemented method for processing an image is disclosed, the method including: receiving an electronic command for creating a printable image from a vector image, the vector image including a first arc connected to a second arc; converting the first arc into a plurality of first line segments, including a first start point and a first end point, the first start point and first end point having a first center point which represents the center of the first arc; converting the second arc into a plurality of second line segments, including a second start point and a second end point, the second start point and second end point having a second center point which represents the center of the second arc; determining that the first end point and second start point are both located at a connection point; determining that the first center point, connection point, and the second center point are aligned in a linear relationship with respect to each other; and adding a connection point shape which extends from the connection point in a tangential direction with respect to the first and second arcs.

### CROSS-REFERENCES TO RELATED APPLICATIONS

This application claims priority to Japanese Patent Application No. 2007-269120, filed Oct. 16, 2007, the disclosure of which is incorporated by reference herein.

### BACKGROUND

1. Technical Field

The present invention relates to an image processing method, a program thereof and an image processing apparatus.

2. Related Art

As an image processing method, a method of converting an image into output image data, which can be printed or output by an electrophotographic color page printer, from a drawing command for performing the drawing of characters/graphics or a drawing state command for setting a line attribute such as a line width, a connection shape and an end point shape or a color is suggested (for example, JP-A-2002-15329). In the image processing method described in JP-A-2002-15329, when a curved line is approximated to a plurality of line segments and the line segments are replaced with rectangles having a predetermined line width, a miter connection for extending the line segments corresponding to the outsides of the curved line until the line segments cross each other is performed.

However, in the image converting method of JP-A-2002-15329, for example, if two arcs are connected and brought into contact such that the tangents of the arcs at the contact point become a completely same straight line, the line segments lengthen and the line segments of the two arcs at the contact point may not be parallel to each other. In this case, if the miter connection is performed, an original shape may not be realized.

### SUMMARY

An advantage of some aspects of the invention is that it provides an image processing method capable of generating an intended image when a vector image is converted into a bitmap image, a program thereof, and an image processing apparatus.

The invention employs the following aspects.

According to an aspect of the invention, there is provided an image processing method using computer software for replacing a curved line with line segments and converting a vector image into a bitmap information, the method including: (a) analyzing a drawing command of the vector image to be converted; (b) determining whether or not a connection point shape adding condition, in which both a drawing command which is previously analyzed in the step (a) and a drawing command which is currently analyzed in the step (a) are drawing commands for drawing arcs, an end point of the drawing command which is previously analyzed and a start point of the drawing command which is currently analyzed are matched with each other at a connection point and the connection point exists on a straight line connected between a central point of the drawing command which is previously analyzed and a central point of the drawing command which is currently analyzed, is satisfied; and (c) adding a connection point shape of a polygon, which has a length equal to or less than a predetermined connection length in an extension direction in which the arcs extend from the connection point and of which a front end has a side substantially perpendicular to the extension direction, to the connection point, if it is determined that the connection point shape adding condition is satisfied in the step (b).

In this image processing method, if the connection shape adding condition, in which both the drawing command, which is previously analyzed, of vector image to be converted and the drawing command which is currently analyzed are the drawing commands for drawing the arcs, the end point of the drawing command which is previously analyzed and the start point of the drawing command which is currently analyzed are matched with each other at the connection point and the connection point exists on the straight line connected between the central point of the drawing command which is previously analyzed and the central point of the drawing command which is currently analyzed, is satisfied, the connection point shape of the polygon which has a length equal to or less than the miter limit length in the extension direction in which the arcs extend from the connection point and of which the front end has the side perpendicular to the extension direction is added. When the vector image file having the connection point between the arc and the arc is replaced with the plurality of rectangles so as to be converted into the bitmap image, in the connection point, the tangents of the previous arc and the current arc are matched, that is, the shape of the line segments of the front end from the connection point is rectangular. However, according to the size of the replaced rectangle or the position of the connection point, the line segment which is inclined at the connection point with respect to the tangential direction may be obtained and, in this case, the unintended shape may be obtained. Here, since the connection point shape is added in the extension direction from the connection point if the connection point shape adding condition is satisfied, it is possible to prevent the unintended shape. Accordingly, it is possible to generate the intended image when the vector image is converted into the bitmap image. Since it is determined whether or not the connection point shape adding condition is satisfied, it is possible to more easily generate the intended bitmap image, compared with a process of making the replaced rectangle smaller and drawing the arc or analyzing the drawing command, computing the direction of the replaced rectangle, obtaining the tangent of the arc, and determining whether or not the rectangle is added as the connection point shape on the basis of the tangent. Here, the “predetermined connection length” may be a length in a range in which the user does not feel any sense of incompatibility although added to the connection point of the arc or a miter limit length.

In the image processing method of the invention, in the step (c), a rectangle having the same width as the line width of two arcs at the connection point may be added as the connection point shape. By this configuration, since the front end of the connection point has an original rectangular shape, it is possible to generate an intended image.

The image processing method of the invention may further include (d) executing a miter connection process at the connection point, if the end point of the drawing command which is previously analyzed in the step (a) and the start point of the drawing command which is currently analyzed in the step (a) are matched with each other at the connection point and the connection point shape adding condition is not satisfied in the step (b). By this configuration, if the connection point shape adding condition is satisfied and the miter connection is performed, it is possible to generate the intended image of which the front end is not sharp, when the front end is likely to become sharp. At this time, in the step (c), the miter connection process may not be executed.

The image processing method of the invention may further include (e) drawing the bitmap image on the basis of the contents of the drawing command analyzed in the step (a). At this time, in the step (a), the drawing command of the vector image to be printed may be analyzed, and in the step (e), if the connection point shape adding condition is satisfied, the connection point shape may be added to the connection point and the bitmap image to be printed may be drawn. Since the bitmap image needs to be generated once at the time of printing, the invention has a significant meaning.

In the image processing method of the invention, in the step (b), it may be determined whether or not both the drawing command which is previously analyzed in the step (a) and the drawing command which is currently analyzed in the step (a) are the drawing command for drawing the arcs, it may be determined whether or not the end point of the drawing command which is previously analyzed and the start point of the drawing command which is currently analyzed are matched with each other at the connection point and the connection point exists on the straight line connected to the central point of the drawing command which is previously analyzed and the central point of the drawing command which is currently analyzed, if both the drawing command which is previously analyzed and the drawing command which is currently analyzed are the drawing command for drawing the arcs, and it may not be determined whether or not the end point of the drawing command which is previously analyzed and the start point of the drawing command which is currently analyzed are matched with each other at the connection point and the connection point exists on the straight line connected to the central point of the drawing command which is previously analyzed and the central point of the drawing command which is currently analyzed, if both the drawing command which is previously analyzed and the drawing command which is currently analyzed are not the drawing command for drawing the arcs. Accordingly, since the unnecessary determining process is not performed, the processing efficiency can be improved.

A program for executing the above-described image processing method on one or a plurality of computers. This program may be recorded on a computer-readable recording medium (for example, a hard disc, a ROM, a FD, a CD, a DVD or the like), may be distributed from any one computer to another computer via a transmission medium (a communication network such as the Internet or a local area network (LAN)), or may be transmitted/received by any method. If this program is executed on one computer or the plurality of computers, the steps of the image processing method are executed and thus the same effect as the image processing method can be obtained.

According to another aspect of the invention, there is provided an image processing apparatus for replacing a curved line with line segments and converting a vector image into a bitmap information, the apparatus including: a command analysis unit which analyzes a drawing command of the vector image to be converted; a determination unit which determines whether or not a connection point shape adding condition, in which both a drawing command which is previously analyzed and a drawing command which is currently analyzed by the command analysis unit are drawing commands for drawing arcs, an end point of the drawing command which is previously analyzed and a start point of the drawing command which is currently analyzed are matched with each other at a connection point and the connection point exists on a straight line connected between a central point of the drawing command which is previously analyzed and a central point of the drawing command which is currently analyzed, is satisfied; and a shape adding unit which adds a connection point shape of a polygon which has a length equal to or less than a predetermined connection length in an extension direction in which the arcs extend from the connection point and of which a front end has a side substantially perpendicular to the extension direction, to the connection point, if it is determined that the connection point shape adding condition is satisfied by the determination unit.

In this image processing apparatus, if the connection shape adding condition, in which both the drawing command, which is previously analyzed, of vector image to be converted and the drawing command which is currently analyzed are the drawing commands for drawing the arcs, the end point of the drawing command which is previously analyzed and the start point of the drawing command which is currently analyzed are matched with each other at the connection point and the connection point exists on the straight line connected between the central point of the drawing command which is previously analyzed and the central point of the drawing command which is currently analyzed, is satisfied, the connection point shape of the polygon which has a length equal to or less than the miter limit length in the extension direction in which the arcs extend from the connection point and of which the front end has the side perpendicular to the extension direction is added. When the vector image file having the connection point between the arc and the arc is replaced with the plurality of rectangles so as to be converted into the bitmap image, in the connection point, the tangents of the previous arc and the current arc are matched, that is, the shape of the line segments of the front end from the connection point is rectangular. However, according to the size of the replaced rectangle or the position of the connection point, the line segment which is inclined at the connection point with respect to the tangential direction may be obtained and, in this case, the unintended shape may be obtained. Here, since the connection point shape is added in the extension direction from the connection point if the connection point shape adding condition is satisfied, it is possible to prevent the unintended shape. Accordingly, it is possible to generate the intended image when the vector image is converted into the bitmap image. Since it is determined whether or not the connection point shape adding condition is satisfied, it is possible to more easily generate the intended bitmap image, compared with a process of making the replaced rectangle smaller and drawing the arc or analyzing the drawing command, computing the direction of the replaced rectangle, obtaining the tangent of the arc, and determining whether or not the rectangle is added as the connection point shape on the basis of the tangent.

The image processing apparatus of the invention may further include a command storage unit which stores the drawing command analyzed by the command analysis unit and a shape storage unit which stores the connection point shape, the determination unit may read the previous drawing command stored in the storage unit and determines whether or not the connection point shape adding condition is satisfied, and the shape adding unit may read the connection point shape stored in the shape storage unit and add the read connection point shape to the connection point, if it is determined that the connection point shape adding condition is satisfied.

### BRIEF DESCRIPTION OF THE DRAWINGS

The invention will be described with reference to the accompanying drawings, wherein like numbers reference like elements.

FIG. 1 is a view showing the schematic configuration of a printer 20.

FIG. 2 is a view explaining a portion of drawing commands included in a vector image file 40.

FIG. 3 is a flowchart showing an example of a print process routine.

FIG. 4 is a flowchart showing an example of an image conversion process routine.

FIG. 5 is a view explaining a state in which drawing commands of an arc are connected and a connection point shape is added.

FIG. 6 is a view explaining another connection point shape.

### DESCRIPTION OF EXEMPLARY EMBODIMENTS

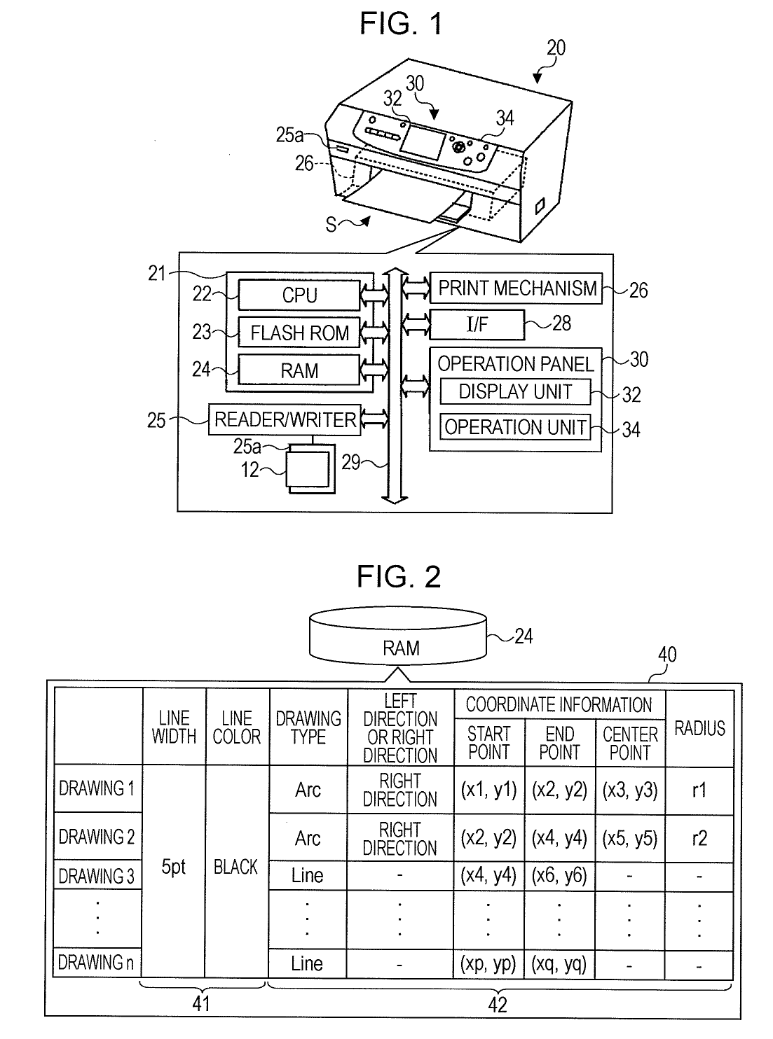

Next, embodiments of the invention will be described with reference to the accompanying drawings. FIG. 1 is a view showing the schematic configuration of a printer 20. The printer 20 includes a controller 21 for controlling the apparatus, a reader/writer 25 which attaches and detaches a memory card 12, which is a portable storage medium, into a slot 25a, a print mechanism 26 for printing an image on a recording sheet S, an interface (I/F) 28 for inputting/outputting information to/from a connected external device (for example, a personal computer (PC)), and an operation panel 30 for displaying the information to a user and inputting the instruction of the user. The controller 21 or the reader/writer 25, the print mechanism 26, the I/F 28, and the operation panel 30 are electrically connected by a bus 29. The controller 21 is constituted by a microprocessor including a central processing unit (CPU) 22 and includes a flash ROM 23 for storing/erasing information and storing various process programs and a RAM 24 for temporarily storing data. Although described in detail later, a connection point shape which is predetermined graphic is stored in the flash ROM 23. A reception buffer (not shown) for temporarily storing a file such as a print job input via the I/F 28 is provided in the RAM 24. Although not shown, the print mechanism 26 is an ink jet mechanism for applying pressure to an ink of each color, discharging the pressurized ink onto the recording sheet S, and performing a print process. The mechanism for applying the pressure to the ink may be realized by the deformation of a piezoelectric element and the generation of air bubbles due to the heat of a heater. The operation panel 30 is a device for inputting various instructions to the printer 20 and includes a display unit 32 including a color liquid panel for displaying characters or images according to the various instructions and an operation unit 34 for performing various operations. The memory card 12 is a non-volatile memory for writing and erasing data and stores a plurality of image files photographed by a photographing device such as a digital camera.

The printer 20 having the above-described configuration has a function for converting a vector image read from the memory card 12 and received via the I/F 28 into a bitmap information and performing printing. The vector image represents an image by a drawing command. If the drawing command is a command for drawing a curved line such as an arc or a circle when the vector image is converted into the bitmap image, the curved line is replaced with a plurality of line segments, that is, a plurality of rectangles, in consideration of a line width. When an end point of a previous drawing command is matched with a start point of a current drawing command at a connection point, a miter connection is performed at the connection point portion. If a line segment which passes through the center of the rectangle and is perpendicular to a line width direction and in which two end points are placed on a side of the rectangle is a central line, the miter connection is a connection process of obtaining the shape of the portion of the connection point which paints out a portion surrounded by extending the outer sides of two rectangles in a direction parallel to the direction of the central lines until the outer sides cross each other when the central lines of two rectangles are connected to each other with an angle. When the curved line is replaced with the rectangles, the miter connection is performed with respect to a portion in which the rectangles cross each other.

A vector image file which is temporarily stored in the reception buffer will be described. FIG. 2 is a view showing an example of a plurality of drawing commands included in the vector image file 40. Drawing auxiliary information 41 which is shared by the drawings and a drawing command group 42 for drawing one connected line among the plurality of drawing commands included in the vector image file 40 are shown. In addition, there are a drawing command for painting out a region and a drawing command for drawing another line, but only the drawing command group will be described herein. The drawing command group includes information such as a line width or a line color as the drawing auxiliary information 41 which is shared by the drawings. The “line width” is set to 5 points and the “line color” is set to a black color. The drawing commands of the drawing command group 42 include an index (“drawing 1”, “drawing 2”, “drawing 3”, “drawing n” and so on in Figure) representing the sequence of the drawing, a “drawing type” representing the type of the drawing, “coordinate information” representing a drawing position and so on, a “radius” of the arc or the circle, and a parameter indicating the arc is drawn in a right direction or a left direction. The “drawing type” includes “Arc” for drawing the arc, “Line” for drawing a line, and “Circle” for driving the circle. The “coordinate” information includes the coordinate information according to the type of the drawing. If the “drawing type” is “Arc”, the coordinate (Xc, Yc) of the central point of the drawn arc, the coordinate (Xs, Ys) of the start point of the drawing and the coordinate (Xe, Ye) of the end point of the drawing are included. If the “drawing type” is the “Line”, the coordinate (Xs, Ys) of the start point of the drawn line and the coordinate (Xe, Ye) of the central point thereof are included. If the “drawing type” is the “Circle”, the coordinate (Xs, Ys) of the start point of the drawn circle and the coordinate (Xc, Yc) of the central point thereof are included. The drawing 1 is the drawing command of which the “drawing type” is the “Arc” and the drawing is performed in the right direction in a state in which the start point is a point SP1 (x1, y1), the end point is a point EP1 (x2, y2), the central point is a point CP1 (x3, y3) and the radius is r1. The drawing 2 is the drawing command of which the “drawing type” is the “Arc” and the drawing is performed in the right direction in a state in which the start point is a point SP2 (x2, y2), which is equal to the end point EP1 of the drawing 1, the end point is a point EP2 (x4, X4), the central point is a point CP2 (x5, y5) and the radius is r2. The drawing 3 is the drawing command of which the “drawing type” is the “Line” and the drawing is performed from the start point which is a point SP3 (x4, y4), which is equal to the end point EP2 of the drawing 2, to the end point which is a point EP3 (x6, y6). The drawing n is the drawing command of which the “drawing type” is the “Line” and the drawing is performed from the start point which is a point SPn (xp, yp) to the end point which is a point EPn (xq, yq). Since the coordinate (Xe, Ye) of the end point of the previous drawing command is equal to the coordinate (Xs, Ys) of the start point of the current drawing command, the drawing command group is a drawing command group for drawing one connected line. The vector image file, for example, includes an XML Paper Specification (XPS) file.

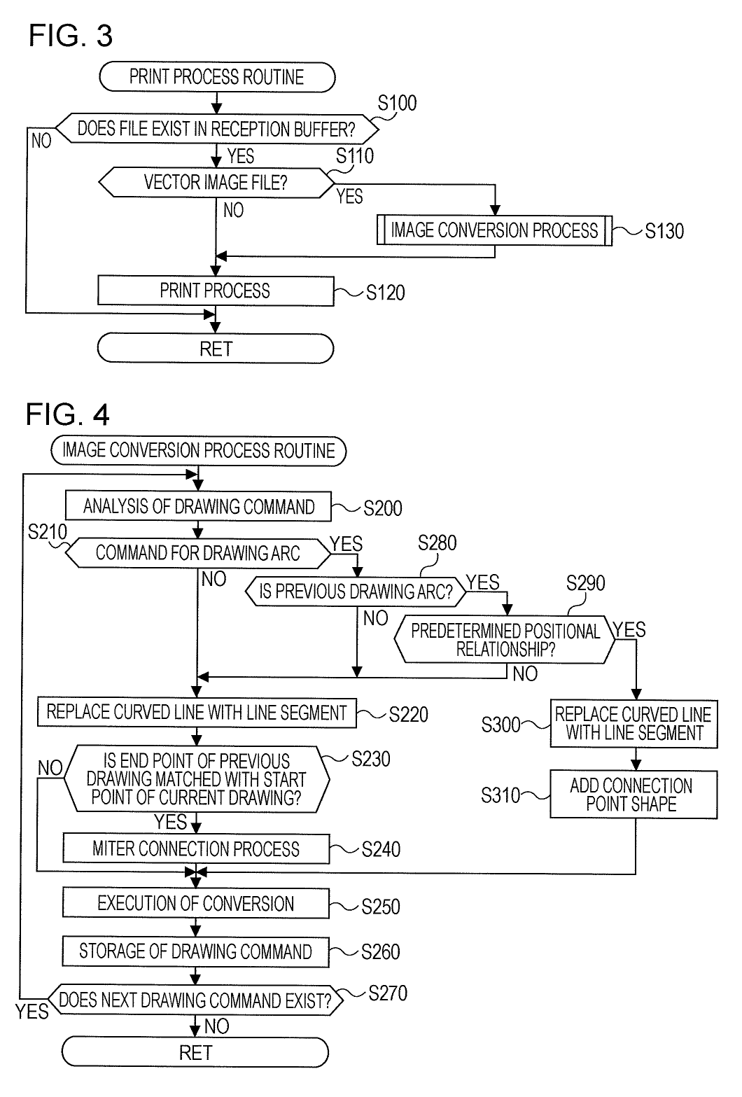

Next, the operation of the printer 20 according to the present embodiment and more particularly the operation when the printing is performed on the basis of the image file which is the vector image will be described. FIG. 3 is a flowchart showing an example of a print process routine executed by the CPU 22 of the controller 21. This routine is stored in the flash ROM 23. This routine is repeatedly executed at every prescribed time (for example, every several ms). When this routine is executed, the CPU 22 first determines whether or not a file is stored in the reception buffer (not shown) of the RAM 23 (step S100). If the file is not stored, it is determined whether the stored file is the vector image file (step S110). It is determined whether or not the file is the vector image file, by determining whether or not an extension of the file is “xps” if an XPS file is considered as the vector image file. If the file is not the vector image file, the print process of the image file is executed (step S120) and this routine is finished. The print process is a process of decompressing an image file converted by a print driver of the PC, converting the image file into bitmap data, and converting the bitmap data into a signal for driving a print head (not shown) of the print mechanism 26, driving the print mechanism 26 using that signal, and discharging an ink to the recording sheet S. Meanwhile, if it is determined that the file is the vector image file in the step S110, an image conversion process is executed such that the vector image file is converted into bitmap data (step S130) and a print process is executed on the basis of the bitmap data after the conversion in the step S130 and this routine is finished.

Now, the image conversion process will be described. FIG. 4 is a flowchart showing an example of an image conversion process routine for executing the image conversion process for converting a line in the image conversion process. This routine is stored in the flash ROM 23. If this routine is executed, the CPU 22 first analyzes one drawing command of the vector image file (step S200). That is, the above-described “drawing type” or the “coordinate information” included in the drawing command is read from the vector image file. Next, it is determined whether or not the drawing command is a command for drawing an arc (step S210). It is determined whether or not the drawing command is the command for drawing the arc, by determining whether or not the “drawing type” is the “Arc”. If the drawing command is not the command for drawing the arc, a curved line other than the arc is replaced with a plurality of line segments (step S220). Actually, since the line width is set in the drawing command for drawing the line, the curved line is replaced with the rectangles. It is assumed that the curved line is replaced with a plurality of rectangles having a width LW and a length of LL and the width LW is equal to the “line width” which is the information included in the drawing command for drawing the line. For example, the drawing command group shown in FIG. 2 is set to 5 points. The length LL is set to a value which is experientially obtained in a range in which a processing speed is allowed. Then, it is determined whether the end point of the drawing (hereinafter, referred to as the previous drawing) due to the drawing command which is previously analyzed and the start point of the drawing (hereinafter, referred to as the current drawing) due to the drawing command which is currently analyzed are matched with each other at the connection point (step S230). If the end point of the previous drawing and the start point of the current drawing are not matched with each other at the connection point, the drawing of the bitmap data to be printed is executed (step S250). That is, the drawing performed by the drawing command is converted into the drawing of the bitmap data according to the “drawing type” or the “coordinate information” included in the drawing command. Then, the drawing command which is currently analyzed is stored in the RAM 24 (step S260) and it is determined whether a next drawing command exists (step S270). If the next drawing command exists, the process after the step S200 is executed. In contrast, when it is determined that the end point of the previous drawing and the start point of the current drawing are matched with each other at the connection point in the step S230, the above-described miter connection process is performed with respect to the connection point between the previous drawing and the current drawing (step S240) and the process after the step S250 is executed such that the drawing is converted into the drawing of the bitmap image. If the drawing command, which is currently analyzed, of the plurality of drawing commands for performing the drawing by drawing the connected line at once is not the arc, the miter connection process for the connection points between the plurality of drawings are performed between that drawing command and the previous drawing command. If the current drawing is a first drawing command of the drawing command group, the miter connection process is not performed because the previous drawing does not exist.

In contrast, if it is determined that the drawing command is the command for drawing the arc in the step S210, the CPU 22 determines whether or not the drawing command which is previously analyzed is the drawing command for drawing the arc by referring to the drawing command which is previously analyzed and is stored in the RAM 24 (step S280) and executes the process after the step S220 if the drawing command which is previously analyzed is not the drawing command for drawing the arc. If the drawing command which is previously analyzed is the drawing command for drawing the arc, it is determined whether or not the previous drawing and the current drawing have a predetermined positional relationship, from the information on the arc of the previous drawing, which is stored in the RAM 24, and the information on the arc of the current drawing (step S290). The predetermined positional relationship indicates a positional relationship in which, when the end point of the previous drawing and the start point of the current drawing are matched with each other and the matched point is the connection point, the connection point exist on a straight line connected between the central point of the arc of the previous drawing and the central point of the arc of the current drawing. If the previous drawing and the current drawing do not have the predetermined positional relationship, the process after the step S220 is executed. In contrast, If the previous drawing and the current drawing have the predetermined positional relationship, the curved line is replaced with the plurality of line segments (rectangles having the width LW and the length LL) (step S300) and the connection point shape is added (step S310), and the process after the step S250 is executed such that the drawing is converted into the drawing of the bitmap image. With respect to the connection point of the rectangles, with which the arc is replaced, other than the connection point between two arcs, the above-described miter connection process is performed. Then, if it is determined that the next drawing command does not exist in the step S270, this routine is finished.

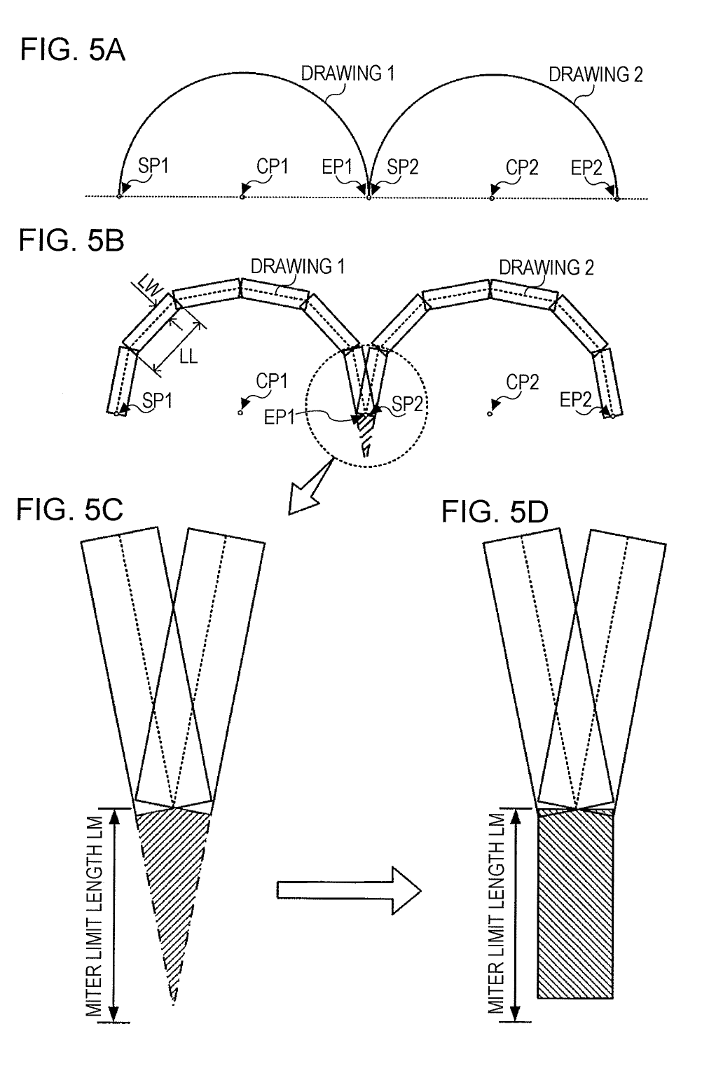

The connection point shape added in the step S310 is stored in the flash ROM 23 as described above. The connection point shape will be described with reference to FIG. 5. FIG. 5 is a view showing a state in which the connection point shape is added when two drawing commands (drawing 1 and drawing 2) of the drawing command group shown in FIG. 2 are converted into the drawing of the bitmap image. As shown in FIG. 5A, the two arcs have the predetermined positional relationship. That is, the previous drawing (drawing 1) is an arc which is drawn in the right direction in a state in which the central point is CP1, the start point is SP1, the end point is EP1 and the radius is r1 and the current drawing (drawing 2) is an arc which is drawn in the right direction in a state in which the central point is CP2, the start point is SP2, the end point is EP2 and the radius is r2. The end point EP1 of the drawing 1 is matched with the start point SP2 of the drawing 2 and the end point EP1 of the drawing 1 and the start point SP2 of the drawing 2 exist on the straight line connected between the two central points CP1 and CP2. If the arcs are replaced with a plurality of rectangles, as shown in FIG. 5B, six rectangles having the line width LW and the length LL are drawn. Here, the tangents of the both arcs at the connection point (the end point EP1 and the start point SP2) are parallel (equal) to each other and the shape of the front end of the connection point between the rectangles with which the arcs are replaced is rectangular. If the above-described condition that the arc and the arc are connected is satisfied, as shown, the rectangles including the connection point cross each other with an angle. Accordingly, if the above-described miter connection is applied to the connection points between the two arcs, a sharp shape is obtained if the length up to the front end having the miter connection shape does not exceed a miter limit length LM which is previously set (see FIG. 5C). Accordingly, in the present embodiment, in this case, the miter connection is not performed and the rectangular connection point shape which is the original shape is added (see FIG. 5D). As shown, the added rectangle has a width equal to the width LW of the rectangle, that is, the line width of the arc, and a length equal to or less than the miter limit length LM.

If, among the drawing commands included in the vector image file to be converted, both the drawing command which is previously analyzed and the drawing command which is currently analyzed are the commands for drawing the arcs and the two arc have the predetermined positional relationship, the rectangular connection point shape which is the original shape is added without performing the miter connection process with respect to the connection point between the two arcs.

Now, the correspondence between the components of the present embodiment and the components of the invention will be described. The process of the step S200 of the image conversion process routine of FIG. 4 of the present embodiment corresponds to a step (a) of the invention, the processes of the steps S210, S280 and S290 correspond to a step (b), and the process of the step S310 corresponds to a step (c). The step S230 and the step S240 correspond to a step (d), the step S250 corresponds to the step (e), the printer 20 corresponds to an image processing apparatus, the controller 21 corresponds to a command analysis unit, a determination unit and a shape adding unit, the RAM 24 corresponds to a command storage unit, and the flash ROM 23 corresponds to a shape storage unit.

According to the printer 20 according to the present embodiment, if both the drawing command, which is previously analyzed, included in the vector image file to be converted and the drawing command which is currently analyzed are the drawing commands for drawing the arcs and the previous drawing and the current drawing have the predetermined positional relationship, the connection point shape of the rectangle which has a length equal to or less than the miter limit length LM in the extension direction in which the arcs extend from the connection point and of which the front end has a side perpendicular to the extension direction is added. When the vector image file having the connection point between the arc and the arc is replaced with the plurality of rectangles (line segments) so as to be converted into the bitmap image, in the connection point, the tangents of the previous arc and the current arc are matched, that is, the shape of the line segments of the front end from the connection point is rectangular. However, according to the size of the replaced rectangle or the position of the connection point, the line segment which is inclined at the connection point with respect to the tangential direction may be obtained and, in this case, when the miter connection is performed, the unintended shape may be obtained as shown in FIG. 5C. Here, since the rectangle is added as the connection point shape in the extension direction from the connection point if the drawing command, which is previously analyzed, included in the vector image file to be converted and the drawing command which is currently analyzed are the drawing commands for drawing the arcs and the previous drawing and the current drawing have the predetermined positional relationship, it is possible to prevent the unintended shape. Accordingly, it is possible to generate the intended image when the vector image is converted into the bitmap image. Since it is determined whether both the drawing command, which is previously analyzed, included in the vector image file to be converted and the drawing command which is currently analyzed are the drawing commands for drawing the arcs and the previous drawing and the current drawing have the predetermined positional relationship, it is possible to more easily generate the intended bitmap image, compared with a process of making the replaced rectangle smaller and drawing the arc or analyzing the drawing command, computing the direction of the replaced rectangle, obtaining the tangent of the arc, and determining whether or not the rectangle is added as the connection point shape on the basis of the tangent.

Since the front end of the connection point has the original rectangular shape, it is possible to generate the intended image. If the end point of the drawing command which is previously analyzed and the start point of the drawing command which is currently analyzed is matched with each other at the connection point, any one of the drawing command, which is previously analyzed, included in the vector image file to be converted and the drawing command which is currently analyzed is not the drawing command for drawing the arc and the previous drawing and the current drawing does not have the predetermined positional relationship, the miter connection process is performed at the connection point and, if both the drawing command, which is previously analyzed, included in the vector image file to be converted and the drawing command which is currently analyzed are the drawing commands for drawing the arcs and the previous drawing and the current drawing have the predetermined positional relationship, the connection point shape of the rectangle is added without performing the miter connection. Accordingly, if both the drawing command, which is previously analyzed, included in the vector image file to be converted and the drawing command which is currently analyzed are the drawing commands for drawing the arcs, the previous drawing and the current drawing have the predetermined positional relationship and the front end has a sharp shape if the miter connection is performed, it is possible to the intended image of which the front end is not sharp. In addition, the drawing command of the vector image to be printed and, if both the drawing command, which is previously analyzed, included in the vector image file to be converted and the drawing command which is currently analyzed are the drawing commands for drawing the arcs and the previous drawing and the current drawing have the predetermined positional relationship, the rectangle of the connection point shape is added to the connection point such that the bitmap image to be printed is drawn. Accordingly, since the bitmap image needs to be generated once at the time of printing, the invention has a significant meaning. It is determined whether both the drawing command which is previously analyzed and the drawing command which is currently analyzed are the drawing commands for drawing the arcs and, thereafter, if it is determined that both the drawing command which is previously analyzed and the drawing command which is currently analyzed are the drawing commands for drawing the arcs, it is determined whether the previous drawing and the current drawing have the predetermined positional relationship. In contrast, if it is determined that both the drawing command which is previously analyzed and the drawing command which is currently analyzed are not the drawing commands for drawing the arcs, it is not determined whether the previous drawing and the current drawing have the predetermined positional relationship. Accordingly, since the unnecessary determining process is not performed, the processing efficiency can be improved.

The invention is not limited to the above-described embodiment and may be variously modified without departing from the technical scope of the invention.

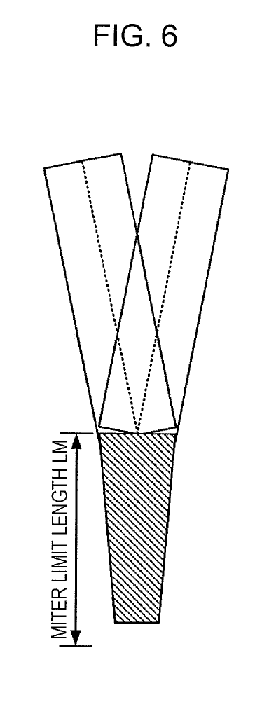

For example, although, in the present embodiment, the rectangle having the width LW shown in FIG. 5D is used as the connection point shape, the invention is not limited to the rectangle having the width LW and a polygon which has a length equal to or less than the miter limit length LM in the extension in which the arcs extend from the connection point and of which the front end has a side substantially perpendicular to the extension direction may be used. For example, the rectangle having a width other the width LW may be used as the connection point shape. Alternatively, a trapezoid shown in FIG. 6 may be used as the connection point shape. As shown, the length of the side of the front end of the trapezoid is shorter in the extension direction of the arc and the length thereof is shorter than the miter limit length LM. In these cases, it is possible to generate the intended image of which the front end is not sharp.

Although, in the above-described embodiment, the length of the rectangle as the connection point shape in the extension direction of the arc is equal to or less than the miter limit length LM, the length may exceed the miter limit length LM if the length is in a range in which the user does not feel any sense of incompatibility.

Although, in the above-described embodiment, the process of the step S290 of determining whether the previous drawing and the current drawing have the predetermined positional relationship is not executed if it is determined that the drawing command which is previously analyzed is not the drawing command for drawing the arc in the step S280 of the image conversion process routine of FIG. 4, the same process as the step S290 may be executed even when the drawing command which is previously analyzed is not the drawing command for drawing the arc. For example, just before the process of the step S280, it may be determined whether or not the connection point shape adding condition that the drawing command which is previously analyzed is the drawing command for drawing the arc and the previous drawing and the current drawing have the predetermined positional relationship is satisfied, the process after the step S300 may be executed if the connection point shape adding condition is satisfied and the process after the step S220 may be executed if the connection point shape adding condition is not satisfied.

Although, in the above-described embodiment, the printer 20 for executing the image conversion process routine shown in FIG. 4 and converting the vector image into the drawing of the bitmap image is described, the invention is not limited to the conversion of the vector image into the drawing of the bit map image if it is determined whether or not the connection point shape is added from the drawing commands of the previous drawing and the current drawing. For example, a module for determining whether or not the connection point shape is added from the drawing commands of the previous drawing and the current drawing, which is assembled into an image processing program for converting the vector image into the bitmap image afterwards, may be used.

Although the image processing apparatus is applied to the printer 20 in the above-described embodiment, any apparatus may be applied to the printer 20 if the vector image is converted into the bitmap image. For example, a printing apparatus for discharging a liquid in which a material such as an electrode material or a coloring material is melt or a liquid-like substance (dispersion liquid) in which the same material is dispersed may be used. Alternatively a computer for performing image processing, a FAX, a scanner, a multifunctional machine, or a photo storage viewer may be used.

What is claimed is:

1. An electronically implemented method for processing an image, the method comprising:
receiving an electronic command for creating a printable image from a vector image, the vector image including a first arc connected to a second arc;
converting the first arc into a plurality of first line segments, including a first start point and a first end point, the first start point and first end point having a first center point which represents the center of the first arc;
converting the second arc into a plurality of second line segments, including a second start point and a second end point, the second start point and second end point having a second center point which represents the center of the second arc;
determining that the first end point and second start point are both located at a connection point;
determining that the first center point, connection point, and the second center point are aligned in a linear relationship with respect to each other; and
adding a connection point shape which extends from the connection point in a tangential direction with respect to the first and second arcs.

2. The method of claim 1 wherein the plurality of first and second line segments include equal widths and equal lengths.

3. The method of claim 1 wherein the connection point shape includes a length which is predetermined.

4. The method of claim 1 wherein the connection point shape is a polygon.

5. The method of claim 4 wherein the polygon is shaped as a trapezoid.

6. The method of claim 4 wherein the polygon is shaped as a rectangle.

7. The method of claim 1 wherein the printable image is a bitmap image.

8. The method of claim 1 further comprising printing the printable image.

9. A computer readable medium including instructions for processing an image, which when executed by at least one processor performs a method, the method comprising:
receiving an electronic command for creating a printable image from a vector image, the vector image including a first arc connected to a second arc;
converting the first arc into a plurality of first line segments, including a first start point and a first end point, the first start point and first end point having a first center point which represents the center of the first arc;
converting the second arc into a plurality of second line segments, including a second start point and a second end point, the second start point and second end point having a second center point which represents the center of the second arc;
determining that the first end point and second start point are both located at a connection point;
determining that the first center point, connection point, and the second center point are aligned in a linear relationship with respect to each other; and
adding a connection point shape which extends from the connection point in a tangential direction with respect to the first and second arcs.

10. The computer readable medium of claim 9 wherein the plurality of first and second line segments include equal widths and equal lengths.

11. The computer readable medium of claim 9 wherein the connection point shape includes a length which is predetermined.

12. The computer readable medium of claim 9 wherein the connection point shape is a polygon.

13. The computer readable medium of claim 12 wherein the polygon is shaped as a trapezoid.

14. The computer readable medium of claim 12 wherein the polygon is shaped as a rectangle.

15. The computer readable medium of claim 9 wherein the printable image is a bitmap image.

16. The computer readable medium of claim 9 wherein the method further comprises printing the printable image.

17. An image processing apparatus, the apparatus comprising:
a processing unit; and
a memory module coupled to the processing unit, the memory module including instructions for processing an image, which when executed by the processing unit performs a method, the method comprising:
receiving an electronic command for creating a printable image from a vector image, the vector image including a first arc connected to a second arc;
converting the first arc into a plurality of first line segments, including a first start point and a first end point, the first start point and first end point having a first center point which represents the center of the first arc;
converting the second arc into a plurality of second line segments, including a second start point and a second end point, the second start point and second end point having a second center point which represents the center of the second arc;
determining that the first end point and second start point are both located at a connection point;
determining that the first center point, connection point, and the second center point are aligned in a linear relationship with respect to each other; and
adding a connection point shape which extends from the connection point in a tangential direction with respect to the first and second arcs.

18. The apparatus of claim 17 wherein the plurality of first and second line segments include equal widths and equal lengths.

19. The apparatus of claim 17 wherein the connection point shape includes a length which is predetermined.

20. The apparatus of claim 19 wherein the connection point shape is a polygon.

21. The apparatus of claim 19 wherein the polygon is shaped as a trapezoid.

22. The apparatus of claim 17 wherein the polygon is shaped as a rectangle.

23. The apparatus of claim 17 wherein the printable image is a bitmap image.

24. The apparatus of claim 17 further comprising a print mechanism coupled to the processing unit, and wherein the method further comprises printing the printable image at the print mechanism.
